(19) United States
(12) Patent Application Publication
(10) Pub. No.: US 2008/0233405 A1
(43) Pub. Date: Sep. 25, 2008

(54) Techniques For Labeling of Plastic, Glass or Metal Containers or Surfaces With Polymeric Labels Employing an Activated Hydrophilic

(76) Inventor: Peter J. Dronzek Jr., Thornwood, NY (US)

Correspondence Address: HEDMAN & COSTIGAN P.C., 1185 AVENUE OF THE AMERICAS, NEW YORK, NY, 10036, US

(21) Appl. No.: 10/587,126

(22) PCT Filed: Jan. 24, 2005
(86) PCT No.: PCT/US05/02269

§ 371 Date: Jul. 21, 2006

Related U.S. Application Data
(60) Provisional application No. 60/538,919, filed on Jan. 24, 2004.

(51) Int. Cl. B32B 17/06; C09J 5/02; B32B 15/04; B32B 9/04; C08L 89/04

(52) U.S. Cl. 428/426; 156/324.4; 156/325; 428/457; 428/411.1; 524/22; 524/18

(57) ABSTRACT

The invention provides a method for fastening a polymeric label to a glass, plastic or metal container or surface by means of a water based composition containing at least 30% by dry weight of animal glue that is activated into an adhesive by the following steps: (a) applying a layer of a hydrophilic solid material based on at least 30% by weight on protein from animal renderings to a polymeric label to form a hydrophilic layer that acts as an adhesive layer when activated with an aqueous medium; (b) applying a low deposition of water, a water based adhesive, water containing a cross-linking agent or an adhesive containing a cross-linking agent to the activatable hydrophilic layer sufficient enough to activate it into an adhesive and form a fastenable polymeric label; (c) fastening the fastenable polymeric label to a glass, plastic or metal container or surface; and (d) allowing said the polymeric label to dry on the glass, plastic or metal container or surface. Special mention is made using polymeric substrates that are optically clear or substrates that are opaque, especially where the opacity is achieved by cavitation or voiding of the substrate to produce pores or voids on the adhesive side of the label while reducing the density of the label substrate.

### FIELD OF THE INVENTION

This invention relates to polymeric sheets or rolls particularly adapted for use as labels in the post mold labeling of plastic, glass or metal containers or surfaces. More particularly, the present invention relates to polymeric film substrates adapted for printing that also have a hydrophilic surface layer activatable into an adhesive layer for use as labels in post mold labeling applications using conventional wet applied water based labeling equipment typically used for the application of paper labels. In another aspect the invention relates to such labels which possess the beneficial properties of the known plastic label substrates, but which are able to be applied on conventional post mold paper labeling equipment using wet applied water based solutions comprising water, water blended with a selected cross-linking agent, adhesives or adhesives blended with a selected cross-linking agent.

### BACKGROUND OF THE INVENTION

Plastic and glass containers or bottles are prevalent in a wide variety of shapes and sizes for holding many different types of materials such as detergents, chemicals, motor oil, beer, etc. These containers are glass or plastic (mono or multi layers) of polyethylene, polypropylene, polyester or vinyl along with other specialty blends for specific barrier and product resistance performance. Generally such containers are provided with a label which designates the trade name of the product and may contain other information as well. The early art which still is prevalent today employed the use of labels manufactured from paper substrates that were applied with a water based adhesive. Subsequently, dry pressure sensitive self adhesives and in mold labels manufactured from paper have been and continue to be used. The shortcomings of paper labels with regard to tearing, wrinkling, creasing and the like due to age and moisture, or due to a lack of deformability when applied to a deformable plastic substrate have been well documented in the labeling industry. Because of this and the need to produce recyclable plastic containers, over the years a great deal of effort has been expended to develop container decoration techniques and durable film substrates which would overcome these shortcomings.

Polymeric film facestocks for container decoration which have resulted from these efforts can be applied to glass and plastic containers as self adhesive pressure sensitive labels as described in the prior art. The use of self adhesive paper and film “pressure sensitive adhesive” (PSA) labels that have been preprinted and supported on a release liner is not a cost effective option because of the added cost of the release liner used to support and render processable the self adhesive face stock. The cost of this type of structure combined with the added cost of disposal of the liner does not make pressure sensitive labeling a desirable option from an economic or environmental standpoint for high volume applications. In addition, PSA labelers typically run much slower than cold glue labelers and capital investment in new labeling equipment is required to transition from wet applied Post Mold Labels (PML) to self adhesive PSA labels. Also a factor is the effect of a new process on an existing packaging line in terms of learning cure and experience.

Another film face stock labeling technique that has evolved is the use of heat activated in-mold labels as described in the prior art where a preprinted plastic label with a heat activated adhesive is placed in the mold before the molten plastic resin is injected or blown into the mold cavity at elevated temperature and pressure which activates the adhesive and fuses the label substrate to the container in-mold resulting in a pre-decorated container as it exits the mold.

The use of polymeric film based in-mold label substrates presents a more cost effective alternative then self adhesive pressure sensitive labels in terms of substrate cost but as this technology has progressed, it has been found that productivity is impacted by the label feeding step into the mold which is performed in a complex, continuous and rapid manner which results in large amounts of scrap material. Also, the initial capital investment required to tool up for a container specific in-mold label process for new molds and the complex electromechanical maintenance intensive feeding devices is significant. Another detriment for this process is the potential inventory carrying costs for varieties of labeled containers that come into play with predecorated containers such as in-mold for those who would choose to apply the label immediately pre or post filled.

Post mold decoration of glass and plastic containers in the current art can also be accomplished by direct screen printing on the container. Direct screen printing on the container is not a cost effective process and also presents the aforementioned inventory problems along with added cost for freight to and from a screen printer. The graphical possibilities for label copy are limited in terms of cost and quality with this technique. Commodity products can not support the cost of this labeling technique.

Another post mold technique that has been popular is the “Therimage” process. This process transfers a reverse printed image from a transfer release sheet under temperature and pressure to produce decorated containers. The “Therimage” technique of transferring a reverse printed image is costly because of transfer sheet costs and presents the same disposal problems and costs with the transfer sheet as occurs with the aforementioned release liner used in conjunction with self adhesive labels. Graphic design and quality is limited with this technique.

Other techniques for labeling various plastic and glass containers with preprinted paper or film label substrates include the use of hot melt adhesives (not aqueous) which are applied to the label substrate or container in a molten state with container and substrate subsequently married while the hot melt is molten. When the hot melt adhesive cools, it sets up and bonds the label substrate to the container. This technology requires the use of sophisticated melting and application equipment that must be operated, cleaned and maintained at elevated temperatures. This technology works well with complete 360 degree wrap around labels but has not evolved to the point to allow consistent labeling of a die cut or square cut label with less than 360 degree wrap. Affixing a cut label to an area on a container with 100% or patterned adhesive application using hot melt adhesives has not been commercially perfected. Complete wrap around hot melt applied labels where one end of the label is affixed to the container while the other end is wrapped around the container and affixed with hot melt to the label substrate is proven hot melt label application technology that works well for film and paper label substrates. This technology does not fit for individually labeled panels on a container such a rectangular oil, contoured detergent or beer containers where discrete labels are applied such as a neck label, front label or rear label that are not wrapped around 360 degrees. Another drawback is the added cost for label substrate when this technique is used since more label substrate is required because of the 100% wrap around.

Lastly, one of the oldest and still prevalent labeling techniques is the application of paper based labels to glass and plastic containers using natural and synthetic labeling adhesives such as BL300 produced by Henkel Adhesives or OC363-20 produced by O.C. Adhesives Corp. which are known in the art. This is a safe (water based) proven technology that has grown and been employed for many years and consequently there are many existing machines that have been installed for this type of labeling technique such as from Krones, Neutraubling, Germany that run cut precut labels or Koyo, Japan which runs roll stock that is cut on machine to the label size. The cut label techniques and associated adhesives work well with paper based substrates applied to glass, plastic or metal containers because the wet adhesive wicks (absorbs) into the paper substrate from the applicator roll, pad or pallet which breathes and allows the moisture from the water carrier to be absorbed by and dry thru the paper base.

This technique obviously will not work well with non-porous polymeric substrates as the adhesive can not wick into the polymeric substrate for initial tack and adhesive transfer to the label or drying thru the plastic. Typically, wet applied cut label machines work where glued pallets rotate and come in contact with a glue applicator roll and become wetted with adhesive. The adhesive wetted pallet then is pressed in contact with the back side of the paper label where the adhesive penetrates the paper fiber with enough initial tack to remove the label out of the label holding magazine while simultaneously gluing the back side of the label. This is accomplished by applying a thin glue film to the pallet picked up from the applicator roll metering system in a pattern or with 100% coverage which is then pressed in intimate contact against the first label in the stack. The glue roller and pallet systems in the current art typically employ a steel glue roller and a hard rubber pallet with a durometer greater than 60 or a rubber glue roller and an aluminum or coater steel pallet. Either combination provides for a firm pallet to transfer the adhesive.

After its removal, the label sticks on the entire glued area of the pallet until transferred to a “gripper” cylinder and removed from the pallet typically using a vacuum mechanism. The gripper cylinder then transfers the label to the container to be labeled. The various machine designs and techniques are well known within the labeling industry and to those skilled in the art. The “Krones Manual Of Labeling Technology” by Hermann Kronseder dated December 1978, is hereby incorporated by reference.

In recent years, as described in U.S. Pat. Nos. 6,663,746 and 6,517,664, which are incorporated by reference, polymeric film labels using a hydrophilic glue receptive layer and a water based adhesive composition are now being used. The applications also describe the concept of rewetting the hydrophilic layer with an aqueous medium (water or adhesive that may contain a cross-linking agent) to activate the hydrophilic layer into an adhesive layer.

Attempts have been made to use polymeric substrates with high moisture vapor transmission rates (MVTR) and tacky or pressure sensitive adhesive on conventional labeling equipment with little success. The tacky adhesive required to stick to the water impervious polymeric substrate causes machining problems by gumming up the adhesive application system and creates cleanup issues. The high MVTR substrates also did not have good wet tack with existing commercially available adhesives that would machine without problems and did not dry rapidly enough making the labels prone to “swimming” or moving from the desired application area during down stream processing.

In addition, the adhesives do not wet out and apply uniformly to non hydrophilic surfaces with the crude adhesive metering and application systems currently in use on existing paper labeling machinery. Without uniform application, wet out and wet tack, it will be impossible to apply a clear label that has the no label look because of adhesive and application imperfections. Recent developments in radiation curable (not aqueous) adhesives adapted for use on cut and stack labelers referenced in issued and pending patent applications to McNutt et. al. have led to the development of more sophisticated adhesive metering mechanisms and label wipers and techniques that can be used to uniformly control adhesive deposition and these modifications are contemplated for use to apply the aqueous activation medium to the activatable layer of the current invention at the minimum possible level.

The techniques of U.S. Pat. No. 6,517,664 and U.S. Pat. No. 6,663,746 which are now being performed commercially and those developed by McNutt et al use adhesives applied to the polymeric film on the labeling machine to affix the label to the container and work well for opaque labels. There are still inconsistencies and imperfections in the application of the adhesive such as bubbles and heavy or light adhesive areas that when applied to clear or contact clear substrates appear inferior when compared to PSA labels where the adhesive has been pre-coated on the substrate. In addition, the radiation curable adhesives as defined by McNutt et. al. are very costly when compared to aqueous systems and in comparison are health and environmental unfriendly.

Accordingly, it is an object of the invention to provide a polymeric label particularly adapted for use in post mold wet applied labeling of polymeric, glass and metal containers that has a dry non pressure sensitive hydrophilic layer uniformly pre-applied that can be activated into a defect free adhesive layer. This is accomplished by pre-applying by coating, coextrusion or extrusion the layer that is activated on the labeling machine with an aqueous medium to become tacky and function as an adhesive to affix the polymeric label to the container. The activated label will readily feed from the label magazine or gripper, adhere with sufficient tack without moving through post labeling handling and processing including but not limited to conveying, filling, case packing and palletizing.

It is a primary object of the invention to provide a polymeric label with a pre-applied hydrophilic layer consisting of at least 30% dry by weight of animal glue activated into an adhesive layer through an aqueous medium on the labeler particularly adapted for use in post mold wet applied labeling of polymeric and glass containers that would have sufficient wet tack and affinity for water, a water based solution or adhesive used to allow for transfer of the water, water based solution or water based adhesive to the polymeric label substrate from the applicator roll(s), pad(s) or pallet(s) of the labeling machine to activate it into an adhesive.

It is also an object of the invention to provide an activatable polymeric label for use in post mold wet applied labeling of polymeric and glass containers that would have a coefficient of expansion or contraction under the conditions which the container sees which is the same or compatible with that of the polymeric resin, glass or metal from which the container is made so that expansion and contraction of the container will not wrinkle or otherwise affect the integrity of the label.

It is also an object of the invention to provide a polymeric label for use in wet applied post mold labeling which would combine suitable properties of modulus of elasticity and flexibility and would not be degraded by handling and flexing of the subsequent container. Finally, it would be desirable to provide a label for use in wet applied post mold labeling of polymeric containers which does not have to be removed from such containers in order to recycle or regrind defective or post consumer polymeric containers.

### SUMMARY OF THE INVENTION

In considering the performance or economic shortcomings of prior art materials, I have discovered an improvement to the process as described in the pending and issued applications by the applicant as cited above by which a polymeric label with a uniform pre-applied hydrophilic layer comprising at least 30% by dry weight of a animal glue can be applied to a container by activating the hydrophilic layer to form a tacky adhesive when wet on the labeler by an aqueous medium before being applied to a glass, plastic or metal container or surface. The process may be carried out in a more consistent and uniform manner than a labeling process that uses a non activatable layer that requires a heavy adhesive layer applied on the label machine to function. The method of the invention comprises:

(a) applying a uniform layer of a hydrophilic solid material containing at least 30% by dry weight of animal glue to a polymeric label based on the combined weight of the hydrophilic solid material and the weight of the animal glue and any additive, e.g. cross-linker, and optionally drying said hydrophilic solid material to form an activatable hydrophilic layer on said polymeric label that can be activated into a tacky adhesive; (b) applying a light deposition water, water containing a cross-linking agent, a water based adhesive or a water based adhesive containing a cross-linking agent over said activatable hydrophilic layer to form a tacky fastenable polymeric label free of bubbles and uneven adhesive streaks typical of the standard deposition of adhesives applied on aqueous labelers;
(c) fastening said fastenable polymeric label to a glass, plastic or metal container or surface; and
(d) curing said polymeric label on said glass, plastic or metal surface or container.

Containers labeled according to the process of the invention, where a cross-linker is present in the dried adhesive composition, are novel articles as they have a label that has not been previously described.

For opaque or metalized labels, special mention is made that it is preferable to use a coextruded polymeric label substrate with a cavitated or voided adhesive surface producing micro-voids or pores on the adhesive side in combination with a porous core. Typically these types of label substrates have a density <0.9 where the adhesive penetrates the rear plane of the label wherein said polymer label contains a portion of said dried water based adhesive within said micro-voided or cavitated polymer label. These label substrates have a density <0.9, preferably below 0.55 to 0.85 and more preferably, from 0.6 to 0.75, and are made of polymers such as polyethylene, polypropylene, polyester, i.e. polyethylene terephthalate, polystyrene, polycarbonate, vinyl, cellophane or compatibilized polymer blends which are described in U.S. Pat. No. 6,517,664, which is incorporated by reference.

The use of the low density micro-voided polymer film can allow portions of the water based adhesive to migrate into the film during the drying cycle to provide an enhanced bond between the polymeric label and the container surface and to also impart stiffness to the dried label on the container surface. Additionally, the weak internal strength of the voided material provides the appearance of superior bond when it is attempted to remove the label because it fractures apart at minimal force. Additionally, the pores create greater surface area for bonding versus a polymeric film with a smooth adhesive surface.

Most importantly, it has been found that voided substrates with a porous adhesive side that are judiciously applied with a hydrophilic layer on the adhesive side show superior adhesion when rewet and pressed onto the glass metal or plastic container because the voided area or open area of the pore has a greater surface area than a non voided smooth surface and appears to act as a suction cup when the air in the cavitated or voided area is pressed out as the label is applied providing an improved bond while pulling activating aqueous medium into the pores.

### DETAILED DESCRIPTION OF THE INVENTION

Pre-applied activatable hydrophilic materials containing animal glue that can function as an adhesive are formulated so that their coefficients of expansion or contraction, thickness and modulus of elasticity when applied to a polymer film will result in a polymeric film facestock that will have hydrophilicity, absorptivity, wet tack and drying properties that will permit the polymer film to be applied to polymeric, glass or metal containers via water based wet labeling techniques on standard paper labeling equipment.

It is contemplated that the pre-applied hydrophilic material will be dried on the polymeric substrate and rewetted at the time that the labeling material is applied to a container. It is also contemplated that the hydrophilic material may be applied at the time of labeling a container just prior to the time when the label is directly applied to a container without drying the hydrophilic material and rewetting the hydrophilic material at the time of labeling. The apparatus which is used to apply paper labels is well known to those in the art. The polymeric label substrate with the activatable hydrophilic layer will demonstrate sufficient “wet tack” during the label application period and the label drying period to permit containers to be handled and processed. The polymeric film based facestock will provide a label with printability, chemical and dimensional stability, resistance to cracking, tearing, creasing, wrinkling or any other degradation of the sort experienced by paper labels due to physical or environmental extremes.

The invention also permits the use of hydrophilic layer activatable by a water based solution into an adhesive to be used to fasten a clear or contact clear polymeric film substrate which is reverse printed and then over coated with the activatable hydrophilic layer to a container. As used herein the reference to a “container” includes a surface of an object made of glass, plastic or metals such as bottles, cans, toys and building materials.

The activatable hydrophilic component or blends containing animal glue will be applied in the present invention to the selected polymeric sheet in a continuous or patterned layer to provide the absorptive, wet tack and drying properties that are necessary to enable polymeric sheets to be successfully used as label substrates on polymeric or glass containers when activated through wetting with water, water and a cross-linker, adhesive or adhesive and a cross-linker using water based wet labeling techniques where the apparatus is configured to apply the minimum amount of aqueous solution to activate the layer into a tacky adhesive when wet, but not excess aqueous medium to saturate the activatable layer causing it to loose its adhesive properties and not adhere well and take a long time to dry. The activatable hydrophilic layer, containing at least 30% by weight of animal glue based on the weight of the hydrophilic solid material and the animal glue which may be applied by either a coating, coextrusion or an extrusion technique, has the function of absorbing moisture to activate the layer as an adhesive when wet with an aqueous medium thus causing selected hydrophilic layers to function as an adhesive without any applied adhesive as is conventionally performed on aqueous labeling machines in the art or to activate by absorbing the moisture from an aqueous adhesive if used, to cause the polymer film to adhere to the glass, plastic or metal container and to set up rapidly and positively. It is important or key to this invention to minimize the amount of aqueous medium used to activate the hydrophilic layer as an adhesive. Excess activation moisture decreases the tack of the activated layer as it becomes saturated with moisture and will lead to longer drying times and loss of adhesion properties. Additionally, the ability to minimize machine applied imperfections such as bubbles and streaks typical as previously mentioned in the current art when heavy adhesive layers are applied on the labeling machine is dictated by the amount of activating medium used and if excess is used, it detracts from the concept of a pre-applied defect free adhesively activated hydrophilic layer.

It is also possible to coextrude the activatable hydrophilic layer with the polymer film layer.

The choice of polymeric substrate for the label film will determine the rigidity, deformability or conformability, regrindability, printability and expansion or contraction characteristics required for application to the selected container without the problems associated with paper labels.

In addition, the polymeric film substrate for the label will be selected so that it will expand or contract to the same degree as the container so that when ambient conditions change, the label will not pucker or blister.

The polymeric materials include clear, opaque or colored polypropylene, polyethylene, polyester, polystyrene, polycarbonate, vinyl, cellophane or compatibilized blends.

The term “film facestock” or “polymeric label substrate” as used herein should be taken for purposes of the present invention to refer to a material compatible in terms of rigidity, deformability or conformability, recyclability if a plastic container and expansion or contraction characteristics with the plastic or glass container to be labeled. Similarly, the “activatable hydrophilic layer” previously mentioned has the properties of minimal tack when dry so labels can be unwound from a roll or separated from a stack and once activated with moisture, it will have the properties of wet tack, absorptivity, drying, sufficient adhesion to the polymeric label substrate and affinity and adhesion to the container or labeling adhesive if used as an activating medium in the wet or dry form.

Activatable hydrophilic layers containing at least 30% animal glue can be wet or remoistened without adhesive for use on a glass, plastic or metal container or a water based adhesive can be used to activate and affix the polymeric label substrate with the activatable hydrophilic layer to the glass, plastic or metal container. For deformable containers, the hydrophilic layer activated into an adhesive is formulated to form a bond with the container and the polymeric film substrate such that when dry, the strength of the container wall-hydrophilic adhesive interface and the cohesive strength of the adhesive itself are all greater than the forces required for deformation of the label.

As used herein and in the appended claims, the term “hydrophilic” is used to describe materials or mixtures of materials which bind, pass or absorb water. The term “activatable hydrophilic layer” describes a hydrophilic layer that when binding, passing or absorbing water becomes activated and transforms into an adhesive layer with wet tack and affinity for the container to be labeled. The term activated as used herein describes the change in a dry pre-applied dry hydrophilic layer on a label substrate to a wet adhesive layer when activated with an aqueous medium that will adhere to the container wall to be labeled, dry and set up with strong adhesion.

The preferred “activatable hydrophilic” materials of the present invention are based on animal glue coating which in broad terms is an organic colloid of protein derivation from collagen which is a protein constituent of hide materials and bones obtained using well know techniques widely used to provide many commercially available glues. Hide animal glue is preferred over bone animal glue because of superior physical properties and strength. The animal source is not critical and glues may be derived from wild or domesticated animals such as horses, cattle, pigs, sheep and the like. Purified versions of animal glue are also known as gelatin. Animal glues are commonly graded on comparative gel gram strength values by manufacturers and provides a rough guide for use but this standard does not always measure their working qualities as adhesives for glass, plastic and metal containers. Considerations of gram strength, pH, ash content, clarity, grease content, type of glue (bone of hide), degree of purification and processing methods all have a bearing. The gram strength measurement of animal glue is also known as a gel strength measurement which ranges from about 30 grams (weak) to 500 grams (exceptionally strong) where the highest gram strengths contain greater amounts of reactive glue protein. Typically, stronger adhesive bonds are achieved with higher gram strength animal glues and blends of animal glues. Unfortunately, as gram strength increases, so does the dry brittleness of the glue which must be addressed in formulating using modifying components such as plasticizers, humectants and modifying synthetic resin dispersions.

In physical form, dry animal glues are odorless, relatively tack free hard materials ranging in clarity from light amber to dark brown depending on the origin, processing technique and degree of purification that contain 10-14% moisture. Almost all grades can be made up into aqueous solutions and many can be melted and applied at temperatures less than the boiling point of water such as through a die or extruder as long as it is vented for potential moisture that could flash off. When aqueous formulations are prepared, the moisture content of the hard material is included in calculating the amount of water added to obtain the desired weight percent dispersion in water of the animal glue. For a clear polymeric substrate, clarity or contact clarity of a thin activatable hydrophilic layer comprising at least 30% animal glue by dry weight dictates that relatively clear and pure animal glue is preferably used.

In water, solutions of animal glues based on hide which are typically the higher gram strength variety preferred for use in this invention instead of bone based glues are generally reaction neutral and have a pH range of 6.4-7.4 which is a pH that makes them compatible with many other materials. The specific gravity of dry animal glue is approximately 1.27.

An important feature of animal glue in the present invention is that when dry animal glue is placed in cold water like an ice chest for beverages, animal glues do not dissolve readily but swell absorbing considerable water forming a gel state and must be heated to dissolve into solution at 100-140° F. The rapid development of a gel state when wet with an aqueous medium provides a fast set and tackiness with quick development of initial bond and holding strength which is critical for the successful application of polymeric labels to glass, plastic and metal containers using wet labeling techniques. For applications where long term contact with water and subsequent swelling of the animal glue could cause a loss of adhesion, it is preferred to crosslink the animal glue to make it moisture resistant. One of the keys to this invention is maintaining the beneficial properties of non cross-linked animal glue for label application using at least 30% animal glue in the activatable hydrophilic layer which is then cross-linked and rendered moisture resistant after application by the water containing a cross-linker or adhesive containing a cross-linker which is applied when the hydrophilic layer is activated into an adhesive. High speed labelers run from 200-1,200 container per minute and the cross-linking reaction is relatively slow at even at high levels of cross-linker so the layer can be wet, develop tack and adhesion to the container to be labeled and cure to moisture resistant over time. This time period varies depending on the activatable layer formulation, cross-linker of choice and amount of each component used along with the amount of water that must be absorbed and dried. The time period can run from 12 hours to 14 days but stable formulations that are rendered moisture resistant in 72 hours are adequate for most commercial labeling applications. A key advantage of cross-linked activated adhesives consisting predominantly of animal glue is that when dry and rendered moisture resistant, the adhesive is not impervious and hard and in fact the adhesive layer will “give” or move slightly under high moisture conditions and contact the surface to be labeled on drying providing a “live” adhesive bond that takes up the stresses and strains that normally occur under labeling and drying conditions. Another key benefit of an adhesive layer containing animal glue that forms a gel structure is that if the surface to be labeled is cool, the animal glue component will gel faster and set a bond faster because it is less fluid. This can be an important factor in brewery applications where post mold labeling of cold beer or cold storage of labeled containers can accelerate the bond of the activatable layer.

Another important feature of animal glue layers, particularly those deposited from water or wet with water is that when dry, they exhibit high adhesive strength, are continuous, non-crystallizing, non-cracking and of great strength and elasticity. Additionally, animal glue is reaction neutral, relatively odorless, non toxic and non corrosive. Due to its unique protein structure, animal glue is not precipitated by acids or alkali's and is resistant to structural breakdown by acids or alkali's within normal practical limits so for use as a labeling adhesive where the contents of a container could leak or drip down the side of the container and attack the adhesive, animal glue is durable. Animal glue based adhesives are also resistant to grease, oil, alcohol and other chemicals that are free of water and as stated above, to overcome moisture sensitivity, animal glue can be rendered moisture resistant by cross-linking.

For glass containers, it is preferred to use high gram strength animal glues at a level of at least 50% dry by weight of the activatable hydrophilic layer to achieve a strong bond where the gram strength of the animal glue is greater than 50 grams and more preferably in the range of 175-225 grams. More preferably, for glass containers a dry level of animal glue between 60-80% is preferred as is a gram strength in excess of 175 grams (also known as gel strength). The higher the gel strength of the animal glue, the stronger the adhesive bond to glass will typically be but also the more brittle the bond will become, especially after crosslinking so the 175-225 gram range while not limiting, is preferred for many applications. Animal glue shows a specific affinity for glass and coated glass and is ideal as a base component to be formulated into an activatable hydrophilic adhesive layer because of its strong wet tack and affinity for glass. Animal glue has such a strong affinity for glass that some formulations when dry and adhered to the glass will pull glass particles with it when removed. This has been proven by those that use animal glue to create chipped glass or frosted glass decorative designs using animal glue allowed to dry on glass that is subsequently removed. This high affinity and bond strength to glass is why animal glue is the key component of this invention for activatable layers on polymeric films for high speed post mold labeling.

For plastic containers, it is recommended to blend synthetic acrylic polymers which bind or absorb water and become adhesives such as polyacrylic acid, polyacrylic acid copolymer or carboxylated sodium polyacrylate with the animal glue to promote adhesion to the plastic container wall. For plastic containers, the dry animal glue level in the activatable layer can range from 30-80% but it is preferred at a level of 35-45% in combination with synthetic polymers. Moisture sensitive synthetic polymers that can be rendered insoluble through cross-linking can be added at levels up to 70% dry polymer

Amounts of non moisture sensitive synthetic polymers can also be added as modifiers at levels up to 50% dry polymer but most preferably at levels up to 25% dry polymer.

If synthetic polymers are used, they can be in the form of solutions, dispersions and emulsions but solution polymers are preferred.

In addition to synthetic resins as discussed above, animal glue solutions are compatible with select natural resins, modifying additives such as plasticizers, oils, fats, waxes along with other adhesive materials such as casein, starch, dextrine and gums under certain conditions.

To plasticize and increase the flexibility of animal glue and control lay flat, humecants (plasticizers) such as urea, polyethylene glycol, glycerin, sorbitol, cane or invert sugars or combinations of the preceding are added at levels up to 40% dry and most preferably 25-30% dry depending on the properties desired but preferably at levels <30% if the activatable layer is subsequently to be reacted (cross-linked) to be rendered resistant to moisture to minimize the level of non-reactive components in the matrix of the activatable hydrophilic layer. It is noted that urea acts as a gel dispersant to reduce the viscosity of the gel for coating applications while it is inert in the animal glue matrix.

As discussed above, a preferred aspect of the present invention is to use cross-linkable (reactive) components in the activating aqueous solution to react with the hydrophilic layer that converts into an adhesive that cures to become more moisture resistant as it dries and builds adhesion to the container wall. Not only does the cross-linking agent make the activated adhesive more moisture resistant, it can provide greater initial wet tack versus using water only and promotes adhesion to the container wall while increasing chemical resistance to materials that may come in contact with the adhesive layer.

Examples of synthetic cross-linkable materials are those which contain carboxyl groups, hydroxyl groups or other functional group which will react with a cross-linking agent. The cross-linking agent can also be added to an adhesive used to wet and activate the hydrophilic layer. When water and a cross-linking agent are combined, the composition will comprise 0.005-10% by wt. of cross-linking agent. Preferred crosslinking agents are Polycup 172 from Hercules and Glyoxal available from BASF Corporation.

The coated, extruded or coextruded activatable hydrophilic layer converts to a wet tacky adhesive layer when wet with an aqueous solution which is defined as a substance capable of combining two surfaces by the formation of a bond. If a light deposition of an aqueous adhesive is used as the activating medium, the activatable hydrophilic layer bonds to the polymeric film substrate and the glass, metal or polymer of the container wall when dry.

The use of the properly formulated activatable hydrophilic layer for a given polymeric labeling substrate and container to be labeled will have a direct effect on the speed which the labeling line can be run. When considering the choice of the activatable material which forms the hydrophilic layer, which may be applied by coating, coextrusion or extrusion, one must consider the label substrate, container to be labeled, labeling machinery, activation technique and down stream processing requirements such as filling, conveying and packing. In addition the final appearance of the label such as the clear no label look or a plain opaque or metalized label must be considered in the choice of the components of the hydrophilic layer. Generally, a deposit of from 0.25 to 8 lbs./3000 square feet of the activatable hydrophilic layer, when dried, may be employed on the polymeric film layer, depending on the particular material that is selected and the method that is used to apply the layer such as coating, coextrusion or extrusion.

It is critical to the successful application and use of an activatable hydrophilic polymeric film label to control how the water or water based adhesive is applied to the activatable hydrophilic layer, how deposition (weight or thickness) is controlled and how the resultant combination with the container is pressed together. Generally, from <0.05 to 2.5 g./sq. ft. of activating medium (water or water based adhesive) is applied to the pre-applied activatable hydrophilic layer with 100% coverage of the label with a preferred range of 0.1-0.25 g./sq. ft. If a grid or other pattern of activating medium is employed, then the amount of activating medium may be reduced. If a grid pattern is employed, the hydrophilic layer may be applied to be substantially in register with the activating medium.

It is critical to the successful application and use of an activatable hydrophilic polymeric film label to precisely control how the amount of aqueous activating fluid medium (water, water plus a cross-linker, adhesive or adhesive plus a cross linker) is applied. To much aqueous medium for a given deposition of activatable hydrophilic layer will overpower the layer and will result in loss of tack and initial adhesion and will result in labels swimming: or moving as the labeled container is conveyed, filled or packed and will increase the drying time of the activated layer to produce a firm adhesive bond to the wall of the labeled container. Not enough aqueous activating medium will not completely develop the full adhesive properties of the activatable layer and will result in poor bonds.

For optimum aqueous medium application control, optical appearance and uniformity, it has been found that it is preferable to use smooth applicator pallets to apply the activating solution which for purposes of this invention includes water, water plus a crosslinking agent, adhesive or adhesive plus a crosslinking agent. The activating solution is not limited to these components but will include them as a major portion of the activating solution with minor components such as biocides, wetting agents, fragrances, humectants, defoaming agents, viscosity modifiers and rheological modifiers also contemplated.

In a preferred embodiment, conventional hard rubber, metal or aluminum glue applicator pallets are modified by adhering a compressible surface like a foam layer with a smooth surface to the adhesive or activating side of the pallet. This allows for intimate contact between the applicator pallet and applicator metering roll when the activating solution is applied to the compressible surface and for intimate contact between the wetted pallet and the hydrophilic layer when the wetted pallet with activating solution is pressed in intimate contact with the hydrophilic layer. Compression of the soft foam like layer as it contacts the wetted applicator roll in contact with the activating solution is important as a means of uniformly controlling pick up of the activator solution. As detailed earlier, it is critical to control the deposition of the activating medium to a low level. The compression of the foam modified pallet in combination with the gap adjustment of the applicator roll system allows for uniform metering and control of the activating solution. An added benefit is that the compression causes a wiping action as the compressible surface of the applicator pallet rotates past the applicator roll to pick up the activating solution providing for a uniform application of solution where uneven application or even foam is smoothed out and made uniform.

When the wetted compressible pallet comes in contact with the activatable hydrophilic layer to pull the label out of the basket for application, the compressible pallet applies pressure on the hydrophilic layer and provides for uniform application and wetting of the activatable hydrophilic layer to promote best optical clarity and ultimate adhesion of the label after drying.

The modified compressible surface must be smooth and wettable which means the activating solution must wet out on the surface. In a preferred embodiment, the foam will compress at least 5% of its thickness for the optimum wiping action and will have a durometer of <50. More preferred is a compressability of about 5-50% of the thickness of the foam of the applicator and preferably >10% and a durometer of about 10-40 and preferably <30 with a glass smooth surface. The type of compressible foam like substance is not limiting but durable compounds like silicone and urethane polymers are preferred.

As with any adhesive labeling technique, the type of bond achieved is a fine balance between the container surface to be labeled, the label material, adhesive formulation which in this case is the activatable hydrophilic layer in combination with the aqueous activating fluid and the deposition of the activated adhesive. For purposes of this invention, the adhesive layer is the combination of the activatable hydrophilic formulation and the activating medium whether it is water, water and a cross-linking agent, adhesive or adhesive and a cross-linking agent. The ultimate adhesion properties are controlled by the surface characteristics of the material to be labeled and the choice of adhesive layer formulation and deposition of the adhesive layer

When using an adhesive or adhesive and cross-linker as the activating fluid, it will generally be possible to reduce the typical amount of adhesive applied to the activatable hydrophilic layer of the label to an amount which is <40% of the amount that is typically employed for affixing paper labels to a surface and preferably less than 20%. For example from 0.02 g. to 0.7 g./sq. cm. may be used for the preparation of labels manufactured from polymeric films with a thickness range from 1.5 to 8 mils.

The choice of the adhesive layer made up of the activatable hydrophilic layer and activating medium, the type of label substrate and container to be adhered together, the plant processing conditions after labeling, storage requirements and the end use requirements that must be met such as high temperature resistance, ice proofness or passing a 24-72 hour ice bath soak are important considerations. There are many more specific variables within these considerations all of which influence the formulation of the proper activatable hydrophilic layer and activating medium for a specific application.

The bonding of the activatable layer can be accomplished with mechanical (non smooth surfaces) and specific adhesion. It has been found that the preferred animal glue component of the activatable layer provides superior adhesion characteristics when the layer is activated by water or a water based adhesive containing a cross-linking agent or a combination of cross-linking agents such as zirconium salts of mineral acids, such as Bacote 20 from Magnesium Elektron, Inc., water soluble polyamide-epichlorohydrin material such as Polycup 172 from Hercules, Glyoxal available from BASF Corporation or an aldehyde donor such as Glutaraldehyde that rapidly cross-links the animal glue and the like which may be used at a level of 0.01-8% by weight of the activatable layer composition.

Mechanical adhesion is defined as the bonding between surfaces in which the adhesive holds the parts together by inter-locking action and actual physical penetration. Specific adhesion is the bonding between surfaces which are held together by molecular forces wherein the surfaces are non porous and no penetration is possible.

These forces are related to the polarity and size of the molecules, pore size of non smooth surfaces and the initial action in obtaining a bond when the activated surface is wet, becomes tacky and a bond develops through molecular forces.

In mechanical as well as specific adhesion, the activated hydrophilic layer must “wet” both surfaces completely or weak bonded areas will develop as it dries or “sets” resulting in a poor bond. Not only is wetting of the surfaces critical, penetration is also important and this is why a polymeric film that is cavitated, voided or porous on the activatable side is a preferred embodiment of the invention in combination with the activatable hydrophilic layer which is penetrated to a degree by the aqueous activating medium. Penetration is important since most combinations of surfaces to be adhered together involve at least one porous or absorptive surface which controls the “setting” characteristics. The preferred low density polymeric labels are made of polypropylene which is commercially available. The preferred density is 0.45 to 0.85; an especially preferred density is 0.50 to 0.65, as distinguished from the conventional polypropylene label stock which has a density above 0.9. These materials are sometimes referred to as cavitated, micro voided or foamed polypropylene. Other polymers which may be used include polyethylene, polyester, polystyrene, cellophane, polycarbonate or compatibilized polymer blends. It is preferred to utilize a low density polymeric label substrate in conjunction with a hydrophilic material such as the activatable hydrophilic layer on the polymeric label to allow for more rapid escape of water from the activating medium that is placed on the activatable hydrophilic layer on the back or adhesive side of the low density polymeric label. One common technique to create cavitation or voids in a stretched polymeric film is to use incompatible particles that separate and create a void or pore as the polymeric film is stretched. A common particle used for creating cavitation or pores is calcium carbonate and animal glues have a strong affinity and bond for calcium carbonate that is typically found in many voided polymeric film layers the activatable adhesive composition will be applied to so it will have superior adhesion.

For non porous polymeric film substrates, to facilitate wetting of the surface and penetration, the activatable hydrophilic layer and activating fluid that combine into the adhesive must wet out the surface of the container to be labeled. This is accomplished by applying the activating medium to the selected activatable hydrophilic layer which when applied to the container to be labeled brings the hydrophilic layer activated into an adhesive and container wall into intimate molecular contact. By using an aqueous fluid activating medium that wets and penetrates the hydrophilic layer as well as the container surface, a fluid region is created that flows to cover the surface as completely as possible. This is critical to the invention where even an apparently smooth surface in reality is composed of a random network of hills and valleys. When the activated hydrophilic layer is in the wet condition, it serves as a wetting bridge to promote adhesion. The more rapidly the activated hydrophilic layer can be applied (pressed in intimate contact with the surface to be labeled), the greater the fluid region will be before the activating medium is absorbed into the hydrophilic layer, the better the wetting at the adhesive interface will be resulting in stronger ultimate bonds and improved optical clarity if a clear film is used.

As previously mentioned, various commercially available natural polymer based products at significantly reduced coat weight can be used as an additive to the animal glue or in the aqueous activating medium with activatable hydrophilic layers to provide good adhesion of polymeric film layers to a plastic or glass surface. These materials include starch based adhesives or casein based adhesives now predominantly used for glass applications since they do not bond well to plastic or metal. Synthetic polymer based materials that may be employed are commercially available and include EVA based materials which have free carboxyl groups, converted starch solutions, PVA based adhesives, synthetic resin dispersions for metal or plastic containers or blends of synthetic and starch and/or casein based products and the like. Acrylic and acrylic/methacrylic polymer dispersions may also be used as synthetic polymer additives. Optionally, if just water or water and a cross-linking agent are used as the activating medium, it is preferred to thicken the water or solution for better machining on the labeler that is designed to handle higher viscosity mediums such as conventional labeling adhesives by adding a thickening amount of a thickener. Many commercially available thickeners can be used but special mention is made of the Laponite family of synthetic thickeners from Southern Clay Products that form a gel structure of an aqueous solution at low addition levels that will not overpower the adhesive properties of the activated medium and will not interfere with the ultimate bond or moisture sensitivity of the dry adhesive at the low levels used to thicken the aqueous solution. Aluminum silicate or other well known natural or synthetic gums may also be added.

It is clear that one specific activatable hydrophilic layer may not fit all applications but it has been found that the activatable hydrophilic layers of the present invention can be tailored to particular applications based on the conditions and requirements for wet PML labeling of polymeric substrates but the activatable layer must contain at least 30% by weight of the dry activatable layer of animal glue that when activated (wet) by an activating fluid medium becomes sufficiently tacky to adhere a polymeric layer to a container through filling, conveying, processing or packing that will subsequently dry and provide good adhesion to the container. When working with natural and synthetic activatable layers that are obviously sensitive to moisture, it is important depending on the moisture sensitivity of the formulation to add a humectant to the activatable layer at a level of 0.25-25% by dry weight to provide curl resistance and to impart lay flat properties to the polymeric film labels. The humectants also tend to act as plasticizing agents so the activatable layer does not become too brittle when dry and include urea, polyethylene glycols such as PEG400, polyvinyl alcohol, glycerin, sorbitol and the like.

For a coextruded product, if an adhesion promoting tie layer is employed, materials such as maleic anhydride, ethyl acrylic acid and the like may be employed at levels up to 5% by weight of the hydrophilic composition. For a coated product, if a primer is employed, materials such as chlorinated polypropylene, polyethylene imine (PEI), acrylic primers and the like may be employed at levels of 0.05-1.0 lbs/3000 sq. ft. Special mention is made of acrylic resin based primers that are filled with a silicate such as colloidal silica also known as “water glass” that has demonstrated superior adhesion characteristics to animal glue that has a high natural affinity for glass and silicates such as alkali metal silicates.

Slip aids and anti-blocking compounds commonly used in the art can prevent excessive friction between the activatable hydrophilic layer and the printed label face and also control the effect of ambient moisture levels which may tend to cause label blocking and interfere with the operation of high speed automated machinery which is used to apply labels. These materials may be used at a level of 0.05-5% by weight of the activatable layer composition and/or the protective over coat applied over the printed indicia on the side of the label opposite the activatable layer and include materials such as microcrystalline wax emulsions, erucamide dispersions, polytetrafluoroethylene compositions, silicone beads, modified silicone solutions, paraffin wax emulsions, high melting polypropylene emulsions, carnauba wax emulsions, oxidized ethylene/EVA compositions, micronized polyethylene wax/PTFE emulsions, micronized polypropylene, micronized fluorocarbons such as PTFE (Teflon), micronized polyethylene, silica and talc. Specific mention is made of the use of silanes to partially crosslink the animal glue in the coating matrix effectively reducing the surface moisture sensitivity of the coating to help prevent blocking and to create a more crystalline surface for improved slip. Of specific note are the Gransil series of silane crosslinkers available from Grant Chemical, Paterson N.J. and specifically Gransil 51 which is a γ-glycidoxypropyl-trimethoxy silane. A preferred defoamer is polypropylene glycol having a weight average molecular weight of about 200-600.

The wetting agent may comprise a non-ionic surfactant such as an ethoxylated nonyl phenol or an ethoxylated amine such as surfynol from Air Products & Chemicals Corporation.

It is contemplated that the activatable hydrophilic layer can be applied in multiple coating steps to have a base layer with humectants for curl control that is very reactive to moisture and would tend to block with an overcoat of a less moisture sensitive layer that can be crosslinked that will resist blocking where the base layer will comprise from 50-90% of the total layer coat weight.

Protective coatings may be used to protect the exposed polymer film and printed indicia of the label when applied at a level of 0.25-4 lbs./3000 sq. ft. using conventional application techniques. These materials include styrenated acrylics such as OC1043 from O.C. Adhesives Inc., urethanes such as AS455 from Adhesion Systems Inc., Flexcon Release Varnish from Flint Ink. In a preferred embodiment, a protective coating with release (non stick) characteristics commonly known in the art is preferred as the protective overcoat to prevent blocking if the stacks of labels are exposed to moisture.

If an antistatic agent is employed in the printable over coat applied over the indicia, it may be present at a level of 0.5-3% by weight of the dry coating. These materials include quaternary ammonium salts such as Ethaquad C12, sulfonated styrene maleic anhydride, sulfonated polystyrene, sulfonated vinyl toluene maleic anhydride, conductive polymers and organo modified silicones such as Silwet L77. It is noted that anti-static agents are typically not needed in the activatable layer because the high moisture content of the animal glue provides exceptional static elimination properties.

Optionally, if a metalized coating of a thin metal film is deposited on the polymeric sheets or rolls, premium quality decorative labels with all of the advantages set forth above will be provided.

It is clear that one specific activatable hydrophilic layer may not fit all applications but hydrophilic layers can be tailored to particular applications based on the conditions and requirements for wet PML labeling of polymeric substrates.

If an adhesion promoting tie layer or primer is employed to promote hydrophilic layer adhesion or adhesive adhesion, materials such as maleic anhydride, ethyl acrylic acid, carboxylated polyurethane resin and the like may be employed at levels of 0.1-3 lb/3,000 sq. ft.

If a cross-linking catalyst is added to the adhesion promoting tie layer, the ratio of catalyst to adhesion promoting tie layer may be an amount that is sufficient to cure the adhesion promoting tie layer. An excess of the catalyst, i.e. 5-25% in excess of the amount of the catalyst that is required to cure the adhesion promoting tie layer may be used to provide a portion of the catalyst at the interface of the adhesion tie promoter and the hydrophilic layer to increase the moisture resistance of the hydrophilic layer without decreasing the moisture absorptivity of the hydrophilic layer. Additionally, excess catalyst can also be available to aid in curing of the adhesive.

The following formula may be utilized for preparing a layer which, after drying, may be utilized as label stock when treated with a suitable activating solution.

### Activatable Hydrophilic Layer Forming Solution

Animal Glue 30-95 wt % preferably 45-60 wt %
Synthetic Or Natural Polymers 5-65 wt %, preferably 40-55 wt %
Cross-linker 0-5 wt %, preferably, <2 wt %
Humectants 0-15 wt %, preferably 5-10 wt %
Wetting Agent 0-1 wt %, preferably <0.5 wt %
Defoamer 0-1 wt % preferably <0.5 wt %
Anti-block Additives 0-2 wt %, preferably <1 wt %
Slip Additives 0-2 wt %, preferably <1 wt %
Water balance to 100 wt %

As noted above, different lots of animal glue in the “dry” state have different levels of retained moisture so that each batch will vary in the content of added water due to the varying water content of the different lots of animal glue.

When a glass substrate is to be labeled, higher levels of animal glue are generally required. When a plastic surface is to be labeled, higher concentrations of added synthetic polymers are generally required.

The following describes an activating solution which may be used in the practice of the invention:

### Activating Solution

Cross-linker 0-10 wt %, preferably 1-10 wt %; especially preferably, 2-4 wt %
Wetting Agent 0-1 wt %, preferably <0.5 wt %
Defoamer 0-1 wt % preferably <0.5 wt %
Thickener 0-2 wt %, preferably <1 wt %
Natural Polymers 0-15 wt %, preferably 5-10 wt %
Synthetic Polymers 0-10 wt %, preferably <5 wt %
Water balance to 100%

The following examples illustrate the invention.

Defined terms and tests are as follows:
Wet Tack,—this is a measure of the initial adhesion of the label to a surface immediately after activation and application to the surface and evaluated by trying to push or slide the label on the surface it was applied to.
Ice Soak—Submersion of the labeled sample in an ice water/cold water bath at a temperature of about 33-38° for 72 hours. After 72 hours, the labeled article is rotated in the bath and labels are evaluated for edge flagging or removal.
Edge Difficulty—this is a measure of the degree of difficulty to lift the edge of the sample after it has been allowed to dry and cure for a specified time period. W denotes wet test after ice soak, D denotes dry test.
Adhesion Rating—this is a measure of the degree of bond of the label to the surface when it is peeled back in a slow continuous motion by hand and is performed right after the edge difficulty test. If an ice soak test is performed, this test is performed on sample pre and post ice soak test.
Adhesive Action—defines whether the activatable layer splits, stays with the label or transfers to the labeled surface after the label is peeled back for the adhesion rating test. If an ice soak test is performed, this test is performed on sample pre and post ice soak test.
Curl—curl is defined as the degree the edges of the label specimen lift when exposed to changing environmental conditions in terms of temperature and humidity.
Blocking—is defined as the degree of tack versus separation of individual labels when the coated side of the label is in contact with the opposite side in a constant humidity chamber (92% RH) for 24 hours at room temperature. Since different films are used, for comparative test purposes the non adhesive side was always evaluated against the same Flexcon varnish from Flint Ink.

All tests except Adhesive Action are rated on a scale of 0 to 3 where 0 is failure, 1 is poor, 2 is good and 3 is excellent. Adhesive Action is denoted as A for split, B stays on label, C transfers to substrate to be labeled.

The term Sample Formulation describes the formulation of the activatable layer. The particular source of the animal glue is not critical and the key property of adhesion is specified as “gram strength”. Materials denoted ACW are moisture absorbing acrylic polymers available from Noveon.

Approximate Coat Weight−is the theoretical coat weight based on the solids of the coating and draw down rod size in grams/MSI MSI=1000 sq. in. To convert to metric equivalent, multiply grams/MSI×1.55 for grams/sq. meter

Type Of Film Used—PET denotes clear polyester—2 mil Shinpex
OPP denotes 2 mil clear oriented polypropylene 196 LL from ExxonMobil or TL50 from Inteplast
WOPP denotes 3.4 mil white cavitated oriented polypropylene 85LP from ExxonMobil
OPS denotes 2 mil oriented polystyrene from Alcoa Kama

All films were corona or flame treated to enhance adhesion. Corona treatment is a process which utilizes a voltage source, an electrode, a dielectric and a ground. High voltage is applied to the electrode and the dielectric is placed between the electrode and the ground. The dielectric comprises the substrate, an insulator, such as a silicone or a ceramic and air. The voltage buildup on the electrode ionizes the air in the electrode/substrate gap, causing the formation of highly energized corona which excites the air molecules, reforming them into a variety of free radicals which then bombard the subtrate surface increasing its polarity by distributing free bond sites across it. The treater may use a dielectric covered roll or a bare-roll which uses a dielectric covered electrode a system for corona discharge treatment may comprise a modified corona treater such as Model AB1977 using a power supply Model No. AB6628, both of which are available from Pillar Technologies, Inc., Heartland Wis.

Surface Labeled—G denotes glass, PET denotes polyester, HDPE denotes High Density Polyethylene

The technique to prepare samples is as follows:

1—Prepare Activatable Hydrophilic formulation
2—Draw down Activatable formulation on selected film substrate
3—Dry in forced hot air oven

### 4—Prepare Activator Solution

5—Apply Activator Solution with foam pad or brush to activate with the minimum amount of solution to activate the coating
6—Rapidly apply the activated label to the surface to be labeled
7—Allow the applied label to dry/cure for 7 days.

All coating and activator formulations are specified in parts by weight per 100 parts of composition and refer to dry parts of components except water.

### EXAMPLE 1

### Activatable Hydrophilic

Formulation—30 parts 192 gram strength Animal Glue
5 parts Urea
5 parts Glycerine
60 parts water

### Film Type—PET

Approx. Coat Weight—4.5 grams/MSI
Activator Formulation—1 part Polycup 172
1 part Glyoxal
98 parts water

### Substrate To Be Labeled—G

| | Wet Edge Difficulty | Adhesion Rating | Adhesive Action |
|---|---|---|---|
| Tack | Pre/Post Ice Soak | Pre/Post Ice Soak | Pre/Post Ice Soak |
| 3 | 3*/2 | 3/2 | A/A |

*film begins to destruct

| Curl | Blocking | Ice Soak |
|---|---|---|
| 3+ | 2 | 3 |

### EXAMPLE 2

### Activatable Hydrophilic

Formulation—30 parts 192 gram strength Animal Glue
5 parts Urea
5 parts Glycerine
59.8 parts water
0.2 parts Silane Crosslinker Gransil 51

### Film Type—PET

Approx. Coat Weight—4.5 grams/MSI
Activator Formulation—1 part Polycup 172
1 part Glyoxal
98 parts water

### Substrate To Be Labeled—G

| | Wet Edge Difficulty | Adhesion Rating | Adhesive Action |
|---|---|---|---|
| Tack | Pre/Post Ice Soak | Pre/Post Ice Soak | Pre/Post Ice Soak |
| 3 | 2/2+ | 3/3 | A/A |

| Curl | Blocking | Ice Soak |
|---|---|---|
| 2 | 3 | 3 |

### EXAMPLE 3

### Activatable Hydrophilic

Formulation—30 parts 192 gram strength Animal Glue
5 parts Urea
5 parts Glycerine
59.8 parts water
0.2 parts Silane Crosslinker Gransil 51

### Film Type—OPP

Approx. Coat Weight—4.5 grams/MSI
Activator Formulation—1 part. Polycup 172
1 part Glyoxal
98 parts water

### Substrate To Be Labeled—G

| | Wet Edge Difficulty | Adhesion Rating | Adhesive Action |
|---|---|---|---|
| Tack | Pre/Post Ice Soak | Pre/Post Ice Soak | Pre/Post Ice Soak |
| 3 | 3/2 | 2+/1+ | C/C |

| Curl | Blocking | Ice Soak |
|---|---|---|
| 1+ | 3 | 3 |

### EXAMPLE 4

### Activatable Hydrophilic

Formulation—30 parts 192 gram strength Animal Glue
5 parts Urea
5 parts Glycerine
59.8 parts water
0.2 parts Silane Crosslinker Gransil 51

### Film Type—OPS

Approx. Coat Weight—4.5 grams/MSI
Activator Formulation—1 part Polycup 172
1 part Glyoxal
98 parts water

### Substrate To Be Labeled—G

| | Wet Edge Difficulty | Adhesion Rating | Adhesive Action |
|---|---|---|---|
| Tack | Pre/Post Ice Soak | Pre/Post Ice Soak | Pre/Post Ice Soak |
| 3 | 3/2* | 2+/2 | A/C |

*Film Splits

| Curl | Blocking | Ice Soak |
|---|---|---|
| 3 | 3 | 3 |

### EXAMPLE 5

### Activatable Hydrophilic

Formulation—30 parts 192 gram strength Animal Glue
2.5 parts Urea
2.5 parts Glycerine
64.9 parts water
0.1 parts Silane Crosslinker Gransil 51

### Film Type—QPP

Approx. Coat Weight—3.2 grams/MSI
Activator Formulation—1 parts Polycup 172
1 parts Glyoxal
98 parts water
50 Substrate To Be Labeled—G

| | Wet Edge Difficulty | Adhesion Rating | Adhesive Action |
|---|---|---|---|
| Tack | Pre/Post Ice Soak | Pre/Post Ice Soak | Pre/Post Ice Soak |
| 3 | 3+/3* | 2 | A/A |

*Film begins to randomly destruct

| Curl | Blocking | Ice Soak |
|---|---|---|
| 3 | 2 | 3 |

### EXAMPLE 6

### Activatable Hydrophilic

Formulation—30 parts 192 gram strength Animal Glue
2.5 parts Urea
2.5 parts Glycerine
64.9 parts water
0.1 parts Silane Crosslinker Gransil 51

### Film Type—WOPP

Approx. Coat Weight—3.2 grams/MSI
Activator Formulation—1 part Polycup 172
1 part Glyoxal
98 parts water

### Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3+ | 3/2 | 2+/ 2 | C/C |

| Curl | Blocking | Ice Soak |
|---|---|---|
| 2+ | 2 | 3 |

### EXAMPLE 7

### Activatable Hydrophilic

Formulation—30 parts 192 gram strength Animal Glue
5 parts Urea
5 parts Glycerine
60 parts water

### Film Type—PET

Approx. Coat Weight—2.5 grams/MSI
Activator Formulation 1 part Polycup 172
1 part Glyoxal
98 parts water

### Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3 | 3/2 | 2.5/1.5 | A/C |

| Curl | Blocking | Ice Soak |
|---|---|---|
| 3 | 2 | 3 |

### EXAMPLE 8

### Activatable Hydrophilic

Formulation—30 parts 192 gram strength Animal Glue
5 parts Urea
5 parts Glycerine
60 parts water

### Film Type—PET

Approx. Coat Weight—7.2 grams/MSI
Activator Formulation—1 part Polycup 172
1 part Glyoxal
98 parts water

### Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3 | 3/3 | 3/3 | A/A |

| Curl | Blocking | Ice Soak |
|---|---|---|
| 2+ | 1 | 3 |

### EXAMPLE 9

### Activatable Hydrophilic

Formulation—30 parts 192 gram strength Animal Glue
5 parts Urea
5 parts Glycerine
59.8 parts water
0.2 Silane Crosslinker Gransil 51

### Film Type—PET

Approx. Coat Weight—7.2 grams/MSI
Activator Formulation—1 part Polycup 172
1 part Glyoxal
98 parts water
Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3 | 3/3* | 3/3 | A/A |

*Film Destructs

| Curl | Blocking | Ice Soak |
|---|---|---|
| 1 | 3 | 3 |

### EXAMPLE 10

### Activatable Hydrophilic

Formulation—30 parts 192 gram strength Animal Glue
2.5 parts Urea
2.5 parts Glycerine
64.9 parts water
0.1 parts Silane Crosslinker Gransil 51

### Film Type—OPP

Approx. Coat Weight—4.5 grams/MSI
Activator Formulation—1 part Polycup 172
1 part Glyoxal
88 parts water
10 parts sucrose

### Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3 | 3+ 3 | 3/2 | C/C |

| Curl | Blocking | Ice Soak |
|---|---|---|
| 3 | 2 | 3 |

### EXAMPLE 11

### Activatable Hydrophilic

Formulation—30 parts 192 gram strength Animal Glue
2.5 parts Urea
2.5 parts Glycerine
64.9 parts water
0.1 parts Silane Crosslinker Gransil 51

### Film Type—OPP

Approx. Coat Weight—2.2 grams/MSI
Activator Formulation—1 part Polycup 172
1 part Glyoxal
88 parts water
10 parts sucrose
Substrate To Be Labeled—G

Wet Edge Difficulty Adhesion Rating

| adhesive | | | |
|---|---|---|---|
| Action Tack | Pre/Post Ice Soak | Pre/Post Ice Soak | Pre/Post Ice Soak |
| 2 | 2+ 1+ | 2/1+ | C/C |

| Curl | Blocking | Ice Soak |
|---|---|---|
| 3 | 2+ | 3 |

### EXAMPLE 12

### Activatable Hydrophilic

Formulation—30 parts 150 gram strength Animal Glue
5 parts Urea
5 parts Glycerine
60 parts water
Film Type—OPP
   Approx. Coat Weight—4.5 grams/MSI
   Activator Formulation—2 part Polycup 172
2 part Glyoxal
96 parts water

### Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3+ | 3/2+ | 2+/2 | C/C |

| Curl | Blocking | Ice Soak |
|---|---|---|
| 3 | 2 | 2+ |

### EXAMPLE 13

### Activatable Hydrophilic

Formulation—30 parts 400 gram strength Animal Glue
5 parts Urea
5 parts Glycerine
60 parts water

### Film Type—PET

Approx. Coat Weight—4.5 grams/MSI
Activator Formulation—2 part Polycup 172
2 part Glyoxal
96 parts water

### Substrate To Be Labeled—G

Wet Edge Difficulty Adhesion Rating

| Adhesive | | | |
|---|---|---|---|
| Action Tack | Pre/Post Ice Soak | Pre/Post Ice Soak | Pre/Post Ice Soak |
| 3+ | 2+/2 | 2/2* | C/C |

*Observed very crystalline and fractures easily

| Curl | Blocking | Ice Soak |
|---|---|---|
| 1+ | 3 | 3 |

### EXAMPLE 14

### Activatable Hydrophilic

Formulation—30 parts 192 gram strength Animal Glue
5 parts Polyethylene Glycol
65 parts water

### Film Type—PET

Approx. Coat Weight—4.5 grams/MSI
Activator Formulation—1 part Polycup 172
1 part Glyoxal
88 parts water
10 parts sucrose

### Substrate To Be Labeled—G

Wet Edge Difficulty Adhesion Rating

| Adhesive | Pre/Post | Pre/Post | Pre/Post |
|---|---|---|---|
| Action Tack | Ice Soak | Ice Soak | Ice Soak |
| 3 | 3/2 | 3/2 | A/A |

*-film begins to destruct

| Curl | Blocking | Ice Soak |
|---|---|---|
| 3 | 3 | 3 |

### EXAMPLE 15

### Activatable Hydrophilic

Formulation—40 parts 192 gram strength Animal Glue
59.8 parts water
0.2 parts Polypropylene Glycol

### Film Type—PET

Approx. Coat Weight—4.5 grams/MSI
Activator Formulation—1 part Polycup 172
1 part Glyoxal
98 parts water

### Substrate To Be Labeled—G

Wet Edge Difficulty Adhesion Rating

| Adhesive | Pre/Post | Pre/Post | Pre/Post |
|---|---|---|---|
| Action Tack | Ice Soak | Ice Soak | Ice |
| 3 | 3/2 | 3/2 | A/A |

*-film begins to destruct

| Curl | Blocking | Ice Soak |
|---|---|---|
| 2 | 2 | 3 |

### EXAMPLE 16

### Activatable Hydrophilic

Formulation—30 parts 192 gram strength Animal Glue
5 parts Urea
5 parts Glycerine
60 parts water

### Film Type—PET

Approx. Coat Weight—4.5 grams/MSI
Activator Formulation—5 parts Polycup 172
5 parts Glyoxal
90 parts water

### Substrate To Be Labeled—G

Wet Edge Difficulty Adhesion Rating

| Adhesive | Pre/Post | Pre/Post | Pre/Post |
|---|---|---|---|
| Action Tack | Ice Soak | Ice Soak | Ice Soak |
| 3 | 2/2 | 1+/1+ | A/A |

| Curl | Blocking | Ice Soak |
|---|---|---|
| 3 | 2 | 3 |

### EXAMPLE 17

### Activatable Hydrophilic

Formulation—35 parts 400 gram strength Animal Glue
2.5 parts Urea
2.5 parts Glycerine
60 parts water

### Film Type—PP

Approx. Coat Weight—2.5 grams/MSI
Activator Formulation—1 part Polycup 172
1 part Glyoxal
0.1 parts Gluteraldehyde
97.9 parts water

### Substrate To Be Labeled—G

Wet Edge Difficulty Adhesion Rating

| Adhesive | Pre/Post | Pre/Post | Pre/Post |
|---|---|---|---|
| Action Tack | Ice Soak | Ice Soak | Ice Soak |
| 3 | 2/1+ | 2/1+ | C/C |

*-Observed very crystalline and fractures easily

| Curl | Blocking | Ice Soak |
|---|---|---|
| 3 | 2+ | 3 |

### EXAMPLE 18

### Activatable Hydrophilic

Formulation—15 parts 400 gram strength Animal Glue
15 Parts ACW97-19 Acrylic Resin
70 parts water

### Film Type—PET

Approx. Coat Weight—4.5 grams/MSI
Activator Formulation—2 parts Polycup 172
2 parts Glyoxal
96 parts water

### Substrate To Be Labeled—PET

Wet Edge Difficulty Adhesion Rating

| Adhesive | Pre/Post | Pre/Post | Pre/Post |
|---|---|---|---|
| Action Tack | Ice Soak | Ice Soak | Ice Soak |
| 3 | 2/1 | 1+/1 | A/B |

| Curl | Blocking | Ice Soak |
|---|---|---|
| 3 | 2 | 2 |

### EXAMPLE 19

### Activatable Hydrophilic

Formulation—15 parts 400 gram strength Animal Glue
15 Parts ACW97-19 Acrylic Resin
70 parts water

### Film Type—PET

Approx. Coat Weight—4.5 grams/MSI
Activator Formulation—2 parts Polycup 172
2 parts Glyoxal
96 parts water

### Substrate To Be Labeled—HDPE

Wet Edge Difficulty Adhesion Rating

| Adhesive | Pre/Post | Pre/Post | Pre/Post |
|---|---|---|---|
| Action Tack | Ice Soak | Ice Soak | Ice Soak |
| 3 | 2/1 | 1+/1 | B/B |

| Curl | Blocking | Ice Soak |
|---|---|---|
| 3 | 2 | 2 |

### EXAMPLE 20

### Activatable Hydrophilic

Formulation—10 parts 400 gram strength Animal Glue
20 Parts ACW97-20 Acrylic Resin
70 parts water

### Film Type—PET

Approx. Coat Weight—4.5 grams/MSI
Activator Formulation—2 parts Aziridine
98 parts water

### Substrate To Be Labeled—PET

Wet Edge Difficulty Adhesion Rating

| Adhesive | Pre/Post | Pre/Post | Pre/Post |
|---|---|---|---|
| Action Tack | Ice Soak | Ice Soak | Ice Soak |
| 3 | 2+/1+ | 2/1+ | B/A |

| Curl | Blocking | Ice Soak |
|---|---|---|
| 3 | 2 | 2 |

I claim:

1. A process for applying a polymeric label to a glass, plastic or metal container or surface said process comprising:
(a) applying a layer of a hydrophilic solid material comprising at least 30% by dry weight of an animal glue based on the total weight of the hydrophilic solid material to a polymeric label and thereafter drying said layer of hydrophilic material to form a water activatable hydrophilic layer that can be activated into a tacky fastenable adhesive;
(b) applying a sufficient amount of water, water containing a cross-linking agent, a water based adhesive or a water based adhesive containing a cross-linking agent to said activatable hydrophilic layer to form a tacky fastenable polymeric label;
(c) fastening said tacky fastenable polymeric label to a glass, plastic or metal container or surface; and
(d) curing said polymeric label on said glass, plastic or metal surface or container.

2. A process for applying a polymeric label to a glass, plastic or metal container or surface as defined in claim 1 wherein the hydrophilic solid material is 90 percent by weight animal glue.

3. A process for applying a polymeric label to a glass, plastic or metal container or surface as defined in claim 1
wherein the polymer for the polymeric label is selected from the group consisting of polypropylene, polyethylene, polystyrene, polyester, polycarbonate, vinyl, cellophane and compatibilized polymer blends.

4. A process for applying a polymeric label to a glass, plastic or metal container or surface as defined in claim 1 wherein step (b) is carried out with the application of a sufficient amount of water to said activatable layer to form a tacky fastenable polymeric label.

5. A process for applying a polymeric label to a glass, plastic or metal container or surface as defined in claim 1 wherein step (b) is carried out with the application of a sufficient amount of water containing an effective amount of a crosslinking agent to said activatable layer to form a tacky fastenable polymeric label.

6. A process for applying a polymeric label to a glass, plastic or metal container or surface as defined in claim 1 wherein step (b) is carried out with the application of a sufficient amount of water containing an effective amount of a crosslinking agent to said activatable layer to form a tacky fastenable polymeric label.

7. A process for applying a polymeric label to a glass, plastic or metal container or surface as defined in claim 1 wherein step (b) is carried out with the application of a sufficient amount of water based activator to said activatable layer to form a tacky fastenable polymeric label.

8. A process for applying a polymeric label to a glass, plastic or metal container or surface as defined in claim 1 wherein step (b) is carried out with the application of a sufficient amount of water based activator containing a effective amount of a cross-linking agent to said activatable layer to form a tacky fastenable polymeric label.

9. A process for applying a polymeric label to a glass, plastic or metal container or surface as defined in claim 1 wherein the total amount of dried hydrophilic material is from 0.02 g to 0.7 g of dried hydrophilic material per sq. cm. of polymer label material.

10. A process for applying a polymeric label to a glass, plastic or metal container or surface as defined in claim 1 where a slip agent is added to said hydrophilic material.

11. A process for making a polymeric label stock for application to a glass, plastic or metal container or surface said process comprising:
(a) applying a layer of an hydrophilic solid material comprising at least 30% by dry weight of an animal glue based on the total weight of the hydrophilic solid material by applying a aqueous dispersion comprising animal glue to a polymeric label stock and thereafter drying said layer of hydrophilic material.

12. A process for making a polymeric label stock for application to a glass, plastic or metal container or surface as defined in claim 11 wherein said aqueous dispersion of animal glue contains a cross-linking agent.

13. A process for making a polymeric label stock for application to a glass, plastic or metal container or surface as defined in claim 12 wherein said aqueous dispersion of animal glue contains a cross-linking agent and an slip agent.

14. A glass, plastic or metal container which is labeled with a label which is fastened to said container with a cross-linked animal glue.

15. A glass, plastic or metal container which is labeled with a label which is fastened to said container with a cross-linked animal glue that is applied by rewetting a label which is treated with a water activatable animal glue.

16. A composition for forming an activatable hydrophillic layer on a surface of label stock, said composition comprising:
animal glue 30-95 wt %;
synthetic and/or natural polymer additive 5-65 wt %;
cross-linker 0-5 wt %;
humectant 0-15 wt %;
wetting agent 0-1 wt %;
defoamer 0-1 wt %;
anti-block additives 0-2 wt %;
slip additives 0-2 wt; and
Water balance to 100 wt %

17. A composition for activating a dried activatable hydrophillic layer on a surface of label stock, said composition, said composition comprising:
cross-linker 1-10 wt %;
wetting agent 0-1 wt %;
defoamer 0-1 wt %;
thickener 0-2 wt %;
natural polymer 0-15 wt %;
synthetic polymer 0-10 wt %; and
water balance to 100%
